(19) United States
(12) Patent Application Publication
(10) Pub. No.: US 2011/0030266 A1
(43) Pub. Date: Feb. 10, 2011

(54) FLYING INSECT CAPTURE APPARATUS

(75) Inventors: SYLVAIN ROY, Huntingdon (CA); JOANNE SERRENTINO, Sault Ste Marie (CA); JOHN RALPH NACCARATO, Sault Ste Marie (CA); JOSEPH ANTHONY SEVERINI, Sault Ste Marie (CA)

Correspondence Address: CASATA TECHNOLOGIES INC.;JOHN NACCARATO, 583 BRULE ROAD, SAULT STE MARIE, ON, P6A5K8, omitted

(73) Assignee: CASATA TECHNOLOGIES INC., Sault Ste Marie (CA)

(21) Appl. No.: 12/502,541

(22) Filed: Jul. 14, 2009

Related U.S. Application Data
(60) Provisional application No. 61/081,258, filed on Jul. 16, 2008.

(30) Foreign Application Priority Data
Apr. 6, 2006 (CA) 2543218

(51) Int. Cl. A01M 1/04

(52) U.S. Cl. 43/113

(57) ABSTRACT

An apparatus for killing insects, the apparatus including one or more host targets for attracting flying insects using one or a combination of ultraviolet light, halogen light, heat, and chemical sensory emissions attractive to flying insects; upper and lower housings connected in a manner to establish a vertical separation to accommodate an air column open to the atmosphere; and one or more insect capture assemblies located to receive the air current having a mesh or other means dimensioned to separate insects from the air current of the air column. The air column is generated by one or more air current generators in the upper and/or lower assemblies to produce a uniform air current open to the atmosphere and flowing vertically at an increased relative speed to the atmosphere thereby creating a zone of differential pressure where the pressure is lowest at the interface between the air column and the atmosphere and increases to atmospheric pressure radially at a distance away from the air column. The differential pressure urges insects into the air column for entrapment into the capture assembly.

Applicant claims the benefit under 35 USC §§120, 121 or 365(c) of the following international application 2543218 filed in Canada on Apr. 6, 2006.

Applicant claims the benefit under 35 USC §§119(e), 120, 121 or 365(c) of the non-provisional application 11947140 of application 60870826 filed in the United States on Dec. 12, 2006.

Applicant claims the benefit under 35 USC §§119(e), 120, 121 or 365(c) of provisional application 61081258 filed in the United States on Jul. 16, 2008.

### TECHNICAL FIELD

The present invention relates generally to attracting and capturing insects.

### BACKGROUND OF THE INVENTION

There are many known devices designed to attract and capture and or kill insects, some which comprise the use of an attractant in combination with a fan apparatus to draw the flying insects into a trap holder.

Mosquitoes and other flying insects are physiologically well equipped to sense electromagnetic radiation from ultra violet to infrared wavelengths; to detect minute changes in pressure, temperature and humidity, and to track their target's scent. It has been reported that structures on the antennae and palpae may detect the scent of the host's odor plume at a distance of up to 30 meters. The mosquito follows the scent trail upwind and makes visual contact at a distance of approximately 10 meters. At a distance of three meters, the mosquito can distinguish warmer areas of the target where blood is near the surface of the skin, using its thermal receptors on the tips of the antennae. There are various species of mosquitoes with many different host-seeking behaviours. Attempts to alter their behaviour with attractants, repellents or inhibitors, and the results are further influenced by such variables as season of the year, time of day, weather and location.

It is well known that light attracts many types of insects, including mosquitoes, so most of the prior art devices include a light source as an attractant. Such devices sometimes take advantage of the light in a range of ultraviolet (UV) and certain infrared wavelengths to attract a specific genus of insect. Fluorescent lights are sometimes used with special phosphors to enhance the ultraviolet spectral content of the emitted light, while other devices rely upon incandescent bulbs. Mosquitoes and other flying insects sometimes react to avoid entrainment in airflows by vigorous flight activity, due to the reflexive defensive reaction to the detection of minute changes in air flow velocity and/or direction. As described in U.S. Pat. No. 5,255,468, it is possible that mosquitoes actually can avoid being pulled into conventional traps and electrocution devices having fans, by sensing the changes in air flow velocity and/or direction prior to being captured in a strong air flow. Such devices however generally only generate a sufficient suction in close proximity to the intake or capture aperture, thereby allowing the flying insect to effect its escape.

Some prior art light-attractant devices also include a fan, with the fan typically designed to establish an air current such that any insect that approaches the light attractant close to the air intake will be irretrievably caught in the air flow and pulled into the device. Research suggests that updraft-type traps may be more effective in some instances than downdraft types, as is disclosed in U.S. Pat. No. 5,255,468. However, the outflow of air creates a turbulent airflow barrier acting to prevent some insects approaching the intake aperture. To alleviate this effect, in U.S. Pat. No. 7,243,458, there is described a device that includes a fan mechanism structured and arranged to provide a counter-flow effect, however, in this case, the outflow still provides a turbulent airflow acting to push insects away from the intake aperture.

Thus, the prior art devices include an attractant, a fan to draw insects into the device, and either a trap for holding the insects, or a means for killing the insects, such as maceration, impact, or grid electrocution (for example, see U.S. Pat. Nos. 2,806,321, 3,041,773, 3,152,420, 4,908,978). However, there are ineffective and variable results produced with each of the prior art devices, as they require the insects to fly with precision into an aperture, air intake, or air current to be irretrievably caught into the device.

Accordingly, there is a need for an insect killer that is relatively quiet, aesthetically appealing, and more effective to attract, capture, and kill species of insects.

### SUMMARY OF THE INVENTION

The present invention overcomes many of the problems with prior art traps and killing devices.

The present invention is a flying insect capture apparatus where flying insects are able to enter the trap from a vicinity around the trap without requiring precision of flight into an aperture, air intake, or air current. The present invention provides for establishing a host target for flying insects through light, heat, and sensory emissions such that flying insects are attracted to the unit and enter a zone of differential pressure whereby they become irretrievably entrained in an air flow from beneath the unit or within close proximity to the air column, and thereby become captured into the trap where they may be killed and disposed of.

The present invention utilizes a uniform flow air column that is open to the atmosphere wherein the air moves vertically as smooth laminar flow at an increased relative speed to the atmosphere thereby creating a differential pressure zone where the pressure is lowest at the interface between the air column and the atmosphere and increases to atmospheric pressure as you move radially away from the air column. When there is a pressure difference, the higher pressure body will convert that excess pressure into kinetic energy which will result in air being moved from outside the air column to inside the air column, and the resultant effect is to create an increased inescapable capture zone for insects flying into the differential pressure zone on approach to the air column.

The size of the differential pressure zone depends on the diameter and velocity of the uniform airflow of the air column. The velocity of the uniform airflow of the air column must exceed the maximum flight speed of the fastest flying insect sought to be captured, and preferably is two times the maximum flight speed of the fastest flying insect sought to be captured. For mosquitoes flying at a speed of 1.5 meters per second, the velocity of the uniform airflow of the air column should be preferably three meters per second.

The velocity of the uniform airflow of the air column can be established by selection of the size of the fan assemblies and the airflow performance capacity of the fan assemblies or other known means for generating an air current. Fan assemblies may be classified into two major types with reference to their mechanical design. A centrifugal fan resembles a paddle wheel, and air enters near the centre of the wheel, turns through a right angle and moves radially outward by centrifugal action between the blades of the rotating impeller. Those blades may be straight or curved either backwards or forwards with respect to the direction of rotation. Each of these designs produces a distinctive performance characteristic. Inlet and/or outlet guide vanes may be fitted to vary the performance of a centrifugal fan. An axial fan relies on the same principle as an aircraft propeller, although usually with more blades. Air passes through the fan along flow-paths that are essentially aligned with the axis of rotation of the impeller and without changing their macro-direction.

To achieve a uniform airflow of the air column of three meters per second using a fan with an exhaust duct diameter of 100 mm, the required airflow performance capacity of the fan is at least 52 cubic feet per minute.

The present invention differs from prior art devices in that the differential pressure zone is a generally increased area around the air column thereby increasing the capture zone without requiring precision of flight from flying insects into an aperture or airflow in close proximity to an intake.

Insects flying into or directed into the differential pressure zone are drawn into the air column where they are thereafter entrained in the vertical air flow and into the capturing apparatus. The increased air velocity of the air column relative to the ambient air beyond the device housing causes a pressure drop towards the air column and a resultant force acting on the flying insect which sucks it inward into the air column where it is thereafter entrained into the airflow and into the insect trap.

The uniform flow air column is established by directing air upwards using any device for creating a uniform non-turbulent air current, such as a fan. At least one lower fan is required, but preferably there are two fans operating in series configuration.

Where two fans are used in a series configuration, the first fan is connected to a power supply and arranged to draw airflow from below the insect capture apparatus through a first insect trap and providing uniform airflow from the first exhaust vertically to form a uniform flow open air column and through a second insect trap and into the intake of a second fan assembly located concentrically above the first fan at a specified physical spacing. The second fan is connected to a power supply and located concentrically above the first fan as described and further arranged to draw uniform airflow from the first exhaust defining the open air column and the ambient air beyond the air column through an insect trap into an intake. The fan assemblies and electrical devices may be enclosed in separate housings that help contain and guide the airflow, thereby increasing the efficiency of the system. The air directed from the first fan can be further accelerated through known ducting means, such as reducing the diameter of the exhaust housing to create a reduced area and increased airflow.

To facilitate more uniform air flow through the open air column, it is preferred that the physical spacing between the two fan assemblies is established using known means from the range from one to 2.5 times the largest fan blade diameter. The physical spacing is preferably established using rigid thin rods with attachment means for connecting the first fan and second fan at the specified distance apart, so as to avoid or control any independent sway or movement of the first fan relative to the second fan.

Air is also drawn from below the insect capture device through the intake of the first fan through an insect trap and is accelerated through the fan upwards into the intake of the fan located above, and through a second trap where such air is then further directed through the fan upwards to exit the unit. The air directed from the bottom fan can be further accelerated through ducting means. The lower fan creates an air flow outside the body in the vicinity of the opening as air is drawn into the fan, and for drawing air in through the opening and into an insect capturing apparatus, for capturing upwardly flying insects in the air flow.

The exhaust airflow of the unit may be directed upwards for dissipation above the unit or alternatively may be deflected a using a cover such that it is exhausted away from the insect capture device in a manner that creates a re-circulating air current to resist the potential escape of flying insects flying within proximity of the exhaust airflow. Preferably the exhaust airflow may be deflected such that it creates a uniform non-turbulent re-circulating air current where flying insects are unable to escape the air current and instead are directed downwards to enter the differential pressure zone or otherwise become entrained in the airflow entering the insect capture device. The exhaust airflow may be further used in combination with a chemical attractant to emit a plume of attractant and lure flying insects to the insect capture device.

The air current capacity of the fans or other like devices may be varied to suit the size of the unit for mimicking a small or large animal, recognizing that the differential pressure zone is reduced in response to a reduction in air current capacity. Typical fans utilized in the present invention operate from at least 60 cubic feet per minute (cfm). Where two fans are used in a series configuration, each fan may have a different size or air current capacity, however preferably the upper fan is of greater size and increased air current capacity than the bottom fan.

Preferably the upper and lower body are comprised of metal cylinders, with the outside of the metal cylinder painted black to radiate energy most quickly. The interior surface of the upper and lower body may be mottled to produce irregular infrared patterns (mottled patterns of cooler and warmer areas). The upper and lower body of the device may be sized to create a visual image and thermal emission of various sized animals to present as a suitable host to flying insects, and may mimic a small animal in the case of attracting mosquitoes and other flying insects, or a larger animal in the case of midge species.

An insect trap may be located at the intake of each fan thereby trapping insects as they fly into the intake of each fan. The insect trap is a structure made from metal, plastic, or paper fibre designed to inhibit passage of insects but allowing air to pass substantially freely through it. The insect trap is preferably designed to be disposable and encourage insects to enter but not leave when the operation of the fans is interrupted or discontinued, such as with a butterfly trap door opening in response to a negative pressure acting on it as with the operation of a fan, or a conically shaped mesh configured to frustrate the escape of trapped insects. The insect trap may comprise a screen material or the like or an adhesive covered surface for holding entrained insects.

Once insects are trapped within the insect capturing apparatus, each trap may be temporarily removed from the capture apparatus for emptying, or preferably may be permanently disposed of to prevent the escape or handling or live and dead insects. The trapped insects may be killed in situ or after evacuation of the trap by various means, including electrocution means located with the insect trap itself; dehydration and starvation caused by entrapment and heat generated by the capture apparatus; fatal impact into each other and/or trap surroundings; burning on disposal; chemical poisoning; simple waste disposal, or pulverization.

The insect attracting and capturing apparatus also comprises one or more means for attracting insects to the vicinity of the air column, such as various light, thermal and or odorants. Preferably the attracting means comprises two light sources and a chemical odorant.

In a preferred embodiment, the first light source emits UV wavelengths with UV-wavelength enhancing phosphors and may be located within the upper body such that it is visible to insects flying within the vicinity of the capture apparatus. The second light source may be of an incandescent or halogen type that emits infrared wavelengths and heat, and is located within the lower metal body such that it is visible to insects flying within the vicinity of the unit. The metal cylindrical lower body traps the heat energy of the second light source, some of which is dissipated as heat through the thin conductive skin of the cylinder housing, and some of which travels through the unit thereby causing the temperature of the unit as whole to increase relative to the atmosphere. The odorant may be located in the exhaust of the upper body such that the odorant is expelled with the exhaust airflow of the unit, and may comprise a carbon dioxide (CO2) emitting means or chemical means such as octenol. Preferably, the odorant is a CO2 emitting means, whereby CO2 is emitted in intervals as opposed to continuously to take advantage of flying insect sensitivities to detecting a change in CO2 concentration rather than a certain threshold level.

The present invention provides for establishing a host target for flying insects through light, heat, and sensory emissions such that flying insects are attracted to the unit and enter a zone of differential pressure whereby they become irretrievably entrained in an air flow from beneath the unit or within close proximity to the air column, and thereby captured into the trap where they may be killed and then disposed.

The present invention may be housed in a decorative housing to suit a particular aesthetic appearance and may be hung as a light fixture, affixed to a light standard, located on a base, or incorporated into other furniture such as an umbrella, planter, or the like.

To capture flying insects that fly close to the ground, the insect capture device is positioned such that the opening of lower housing is at least one foot and preferably about three feet elevated above ground level. To capture other species that fly at higher elevations, insect capture device can be positioned at a higher elevation such as at six feet.

Accordingly, it is an object of the present invention to provide an improved insect attracting, capturing and killing apparatus, particularly effective for capturing and killing mosquitoes.

It is another object of the present invention to provide an insect attracting and capturing device that takes advantage of the host-seeking behaviours of insects such as mosquitoes.

It is another object of the present invention to provide an insect attracting and capturing device that may be adapted to imitate the sensory emissions of small and large animals, depending on the target insects sought to be controlled or eliminated.

It is another object of the present invention to provide an insect attracting and capturing device that does not require precision of flight of insects into an aperture or airflow.

It is another object of the present invention to provide an insect attracting and capturing device that prevents the escape of insects such as mosquitoes as they fly into close proximity of the unit.

It is another object of the present invention to provide an insect attracting and capturing device that is economical, quiet and effective.

It is another object of the present invention to provide an insect attracting and capturing device that takes advantage of the anticipated increased capture rates with updraft-type traps but including means for killing the insects.

These and other objects, features and advantages of the present invention will become apparent from consideration of the following detailed description of the disclosed embodiments and by reference to the accompanying drawings and claims.

### BRIEF DESCRIPTION OF DRAWINGS

FIG. 1 is a diagrammatic view of an insect attracting and capture device according to the invention.

FIG. 2A is a diagrammatic view showing the use of a butterfly trap in a closed position in combination with the device in FIG. 1.

FIG. 2B is a diagrammatic view showing the use of a butterfly trap in an open position in combination with the device in FIG. 1.

FIG. 3 is a diagrammatic view of the insect attracting and capture device in FIG. 1 with a mounting bracket for attaching to a wall, pole or other rigid structure.

FIG. 4 is a diagrammatic view of the insect attracting and capture device in FIG. 1 in a pedestal configuration.

FIG. 5 is a diagrammatic view of the insect attracting and capture device in FIG. 1 in a second embodiment.

### DETAILED DESCRIPTION

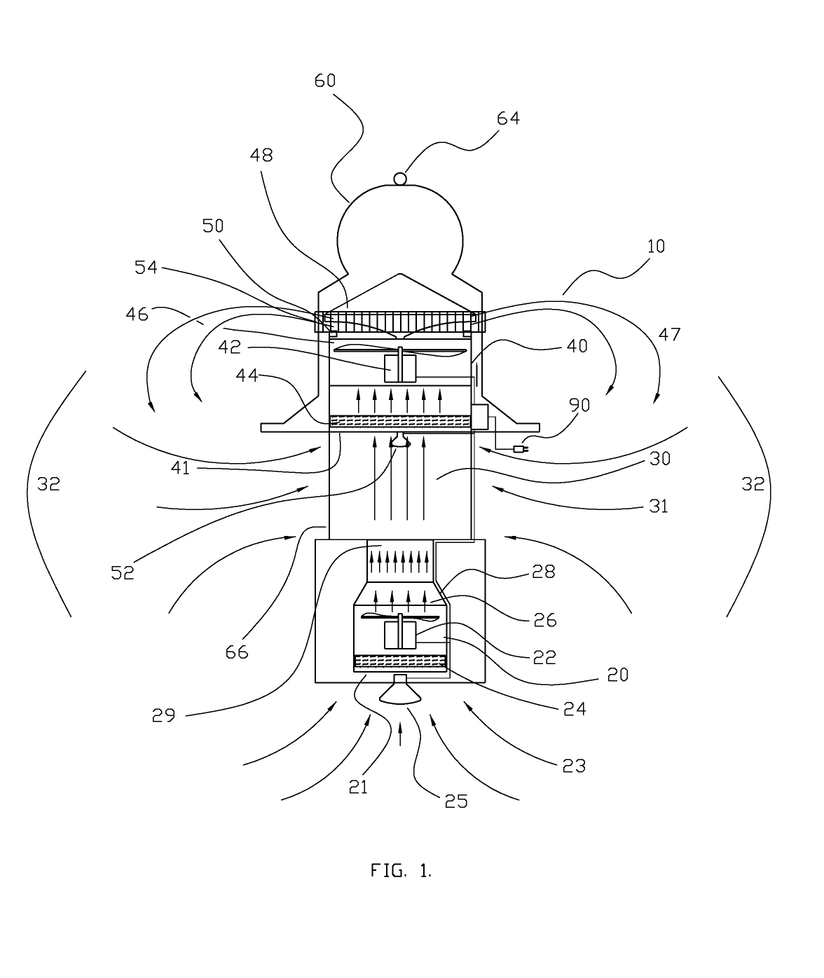

Referring now to the insect capture device 10 illustrated in FIG. 1, there is a lower housing 20 made from thermally conductive metal and an upper housing 40. The lower housing 20 contains an air intake opening 21 and encloses an electrical fan 22 and an insect trap 24 positioned beneath the electrical fan 22. The electrical fan 22 draws air from an area 23 that is generally exterior and beneath the capture device 10 into the intake opening 21 and through the trap 24. The generated airflow 26 is directed upwards through a duct 28 and exhaust 29 into an air column 30.

The lower housing 20 further contains a light source attractant 25, wherein said light source is capable of emitting light of incandescent or infrared wavelengths and generating heat as an additional attractant means. The insect trap 24 positioned in the lower housing 20 is a mechanism or structure for inhibiting passage of insects but allowing air to pass substantially freely through it, and is positioned beneath the electrical fan 22. The insect trap 24 may be designed to be disposable, encourage insects to enter but not leave, and may contain a screen material or the like, or an adhesive covered surface for entrapping entrained insects.

The lower housing 20 and upper housing 40 are separated using a physical means 66 such as a rod to define a space enclosing the air column 30 located generally concentrically beneath the air intake opening 41. The air column 30 is formed from the airflow 26 as well as air drawn from an area 31 that is generally exterior to air column 30. The air within the air column 30 flows upwards at an increased velocity relative to air from the area 31 that is generally radially exterior to air column 30, thereby causing a differential pressure zone 32 where the pressure is lowest at the interface between the air column and the atmosphere and increases to atmospheric pressure as you move radially away from the air column.

The upper housing 40 contains an air intake opening 41 and encloses an electrical fan 42 and an insect trap 44 positioned beneath the electrical fan 42. The electrical fan 42 draws air from the air column 30 into the intake opening 41 and through the insect trap 44. The exhaust airflow 46 is directed upwards and deflected using a cover 48 such that it is exhausted away from the above the device 10 such that it creates a re-circulating air current 47 where flying insects are unable to escape the air current 47 and instead are directed to enter the differential pressure zone 32 or otherwise become entrained in the airflow 31 or airflow 23 entering the insect capture device.

The insect trap 44 positioned in the upper housing 40 is a mechanism similar in structure and function to the insect trap 24, and is a structure for inhibiting passage of insects but allowing air to pass substantially freely through it. The insect trap 44 is positioned beneath the electrical fan 42. The insect trap 44 may be designed to be disposable, encourage insects to enter but not leave such as with a butterfly trap door or conically shaped mesh, and may contain a screen material or the like or an adhesive covered surface for entrapping entrained insects.

The upper housing 40 further contains means for attaching or containing an odorant or other chemical attractant 50 such that the exhaust airflow 46 is utilized to expel chemical attractant from the unit. The insect chemical attractant 50 may be a liquid, solid, or gas-emitter selected from those well known in the art, including an appropriate insect pheromone, carbon dioxide, a kairomone, octenol, or such as may yet be discovered. The insect chemical attractant 50 is mixed with the exhaust flow 46 and discharged though openings 54 of a decorative housing 60 enclosing the upper housing 40.

The upper housing 40 further contains a light source attractant 52, wherein said light source is capable of emitting light of ultraviolet wavelengths as an additional attractant means.

In the embodiment described in FIG. 1, fan 22 has a nominal 100 mm opening and produces from at least 60 cubic feet per minute of airflow. Fan 42 has a nominal 150 mm opening and produces from at least 80 cubic feet per minute of airflow from a static position. Power 90 can be provided to the device 10 to operate the each fan and lights by any suitable and convenient means, such as, for example, batteries, solar panels or line power. The device 10 may attached to a standing fixture or suspended from a hook using attachment means 64. Flying insects 80 are drawn toward to the device 10 in reaction to the combination of visual, chemical, and thermal attractants. As the insects 80 follow their target-seeking instincts, they are led naturally to the differential pressure zone 32 or lower area 23 and are drawn into the device 10 through the air column 30 or suction from the lower fan assembly 22, and are thereby urged by suction flow 31 to enter the insect trap 44 or urged by suction flow 23 to enter the insect trap 24.

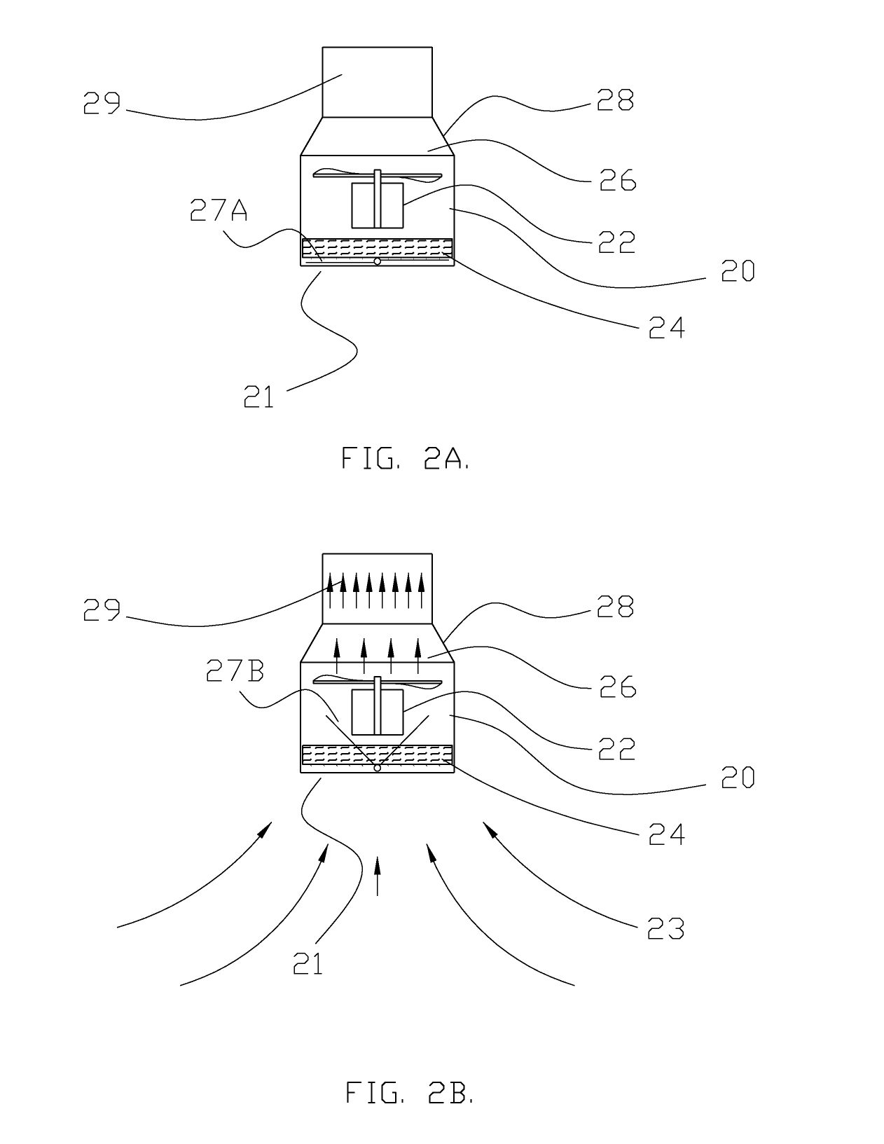

Referring to the insect capture device illustrated in FIG. 2A, there is a lower housing 20 made from thermally conductive metal, comprising an air intake opening 21 and encloses an electrical fan 22 in a non-operating state and a butterfly trap 24 in a closed position beneath the electrical fan 22 wherein the butterfly trap 24 remains in a closed position when the fan 22 is not operating, thereby not allowing trapped insects to escape. Referring to insect capture device illustrated in FIG. 2B, there is a lower housing 20 made from thermally conductive metal, comprising an air intake opening 21 and encloses an electrical fan 22 in an operating state and a butterfly trap 24 in a open position beneath the electrical fan 22 wherein the butterfly trap 24 remains in a open position when the fan 22 is operating, thereby allowing insects to enter into the trap. The electrical fan 22 draws air from an area 23 that is generally exterior and beneath the capture device 10 into the intake opening 21 and through the trap 24. The generated airflow and associated negative pressure allows the butterfly trap 24 to open and receive flying insects entrained in the airflow.

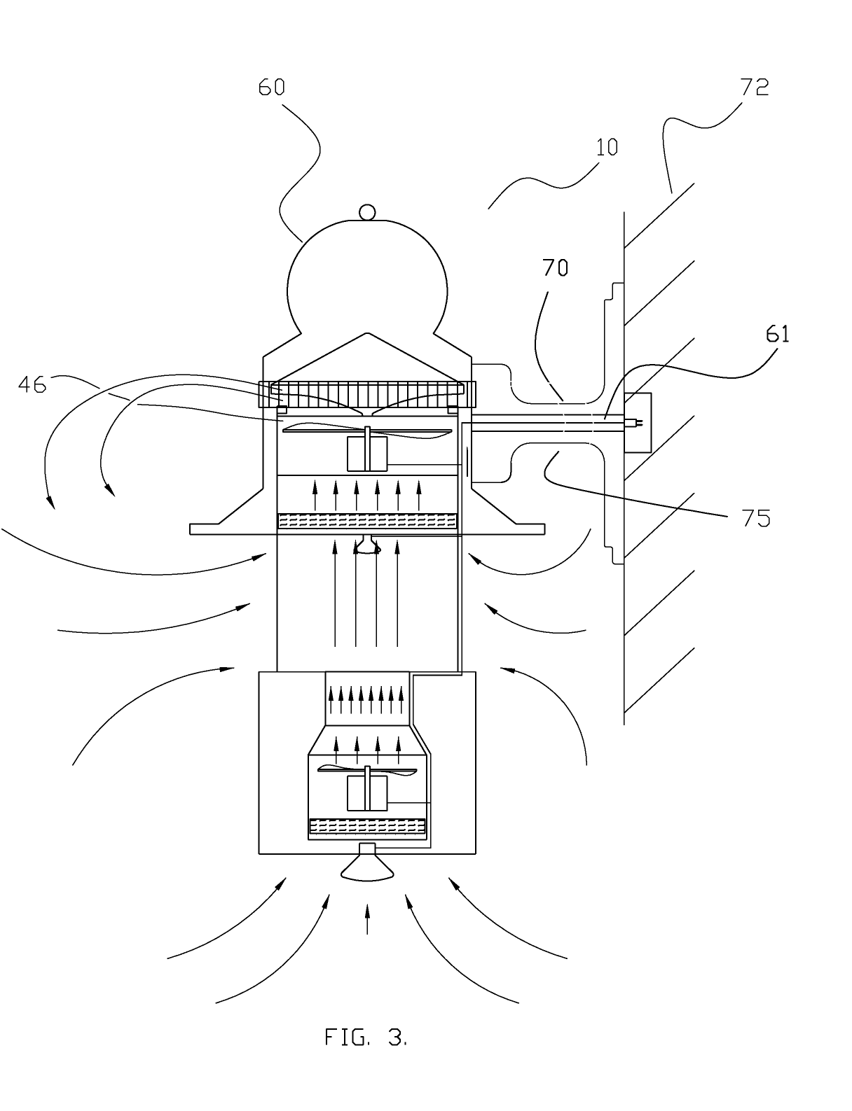

Referring to the insect capture device 10 illustrated in FIG. 3, there is included a bracket 70 made of metal, plastic or other low cost material attached to the device 10 using known attachment means (such as a nut and bolt arrangement, rivets, weld or the like), and a conduit means 75 within the bracket for housing the electrical connection 61 to a power source. The bracket 70 is then attached to a wall 72 or other rigid structure such as a pole and the like to position the device 10 in an area for attracting and trapping flying insects. The device 10 may be partially enclosed within a decorative housing 60 designed to shield the device 10 from adverse weather conditions and suit the aesthetic appeal of the user.

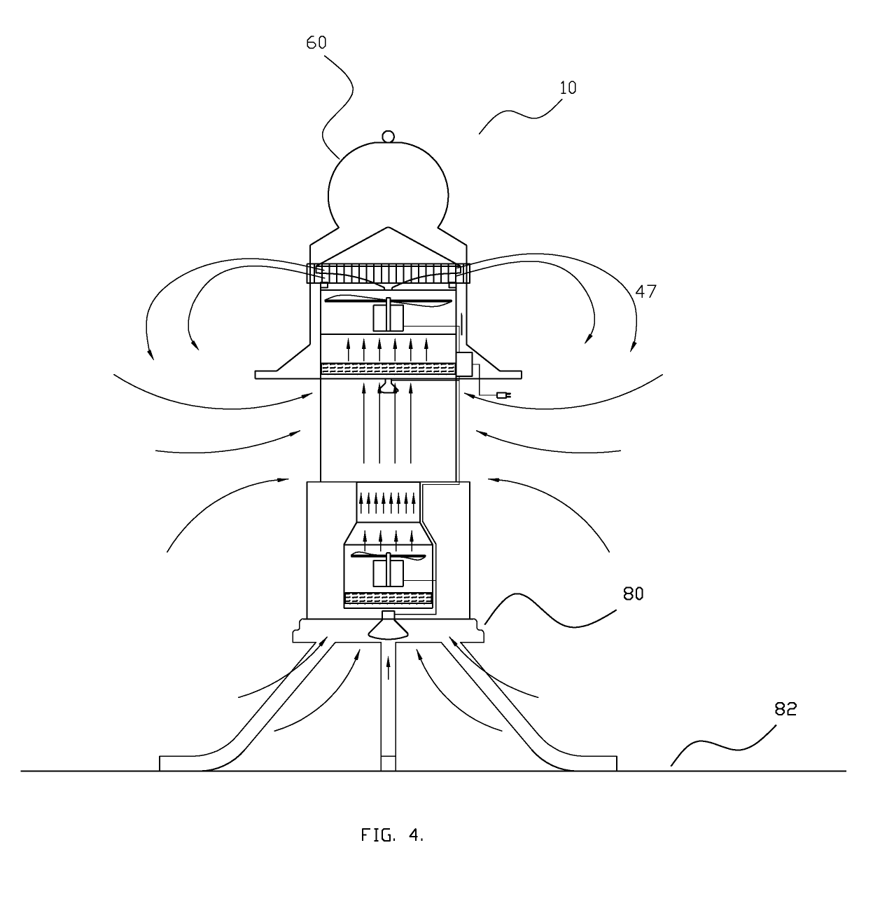

Referring to the insect capture device 10 illustrated in FIG. 4, there is included a pedestal 80 made of metal, plastic or other low cost material attached to the device 10 using known attachment means (such as a nut and bolt arrangement, rivets, weld or the like). The pedestal 80 is designed for supporting the device 10 on a floor or other surface 82 at an elevation from one to three feet to position the device 10 in an area for attracting and trapping flying insects. The device 10 may be partially enclosed within a decorative housing 60 designed to shield the device 10 from adverse weather conditions and suit the aesthetic appeal of the user.

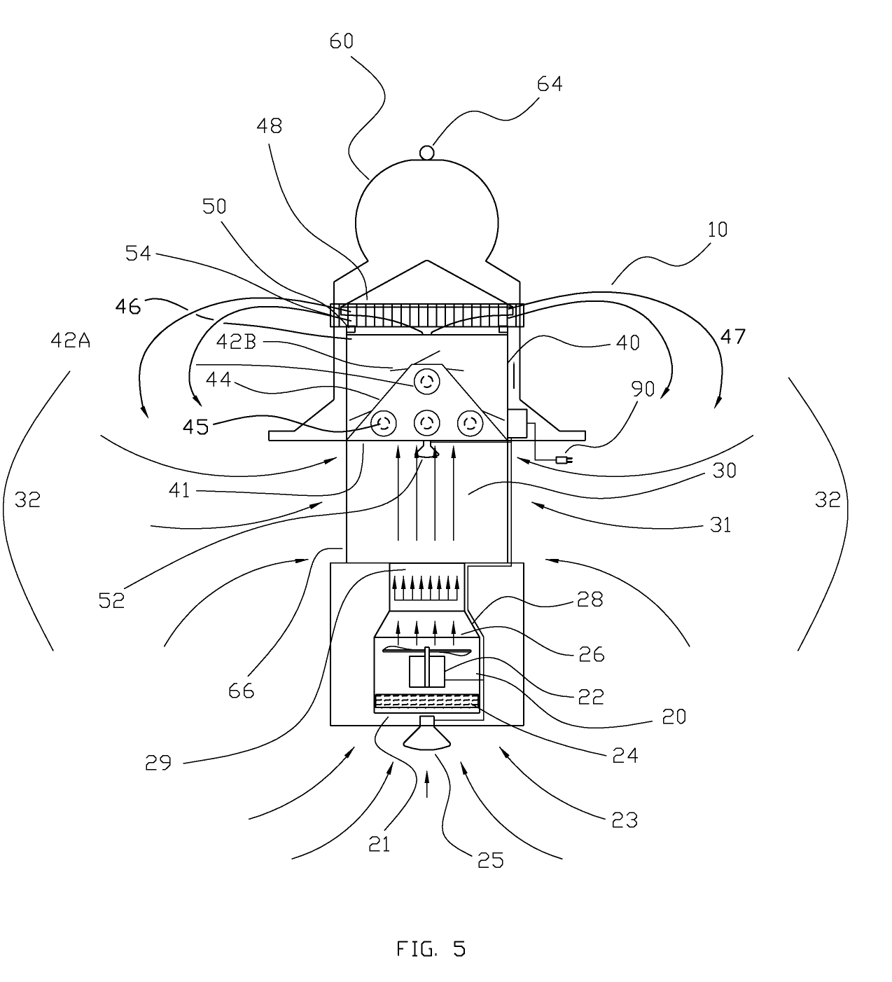

Referring to the insect capture device 10 illustrated in FIG. 5, there is a lower housing 20 made from thermally conductive metal and an upper housing 40. The lower housing 20 contains an air intake opening 21 and encloses an electrical fan 22 and an insect trap 24 positioned beneath the electrical fan 22. The electrical fan 22 draws air from an area 23 that is generally exterior and beneath the capture device 10 into the intake opening 21 and through the trap 24.

The generated airflow 26 is directed upwards through a duct 28 and exhaust 29 into an air column 30. The lower housing 20 further contains a light source attractant 25, wherein said light source is capable of emitting light of incandescent or infrared wavelengths and generating heat as an additional attractant means.

The insect trap 24 positioned in the lower housing 20 is a mechanism or structure for inhibiting passage of insects but allowing air to pass substantially freely through it, and is positioned beneath the electrical fan 22. The insect trap 24 may be designed to be disposable, encourage insects to enter but not leave, and may contain a screen material or the like, or an adhesive covered surface for entrapping entrained insects.

The lower housing 20 and upper housing 40 are separated using a physical means 66 such as a rod to define a space enclosing the air column 30 located generally concentrically beneath the air intake opening 41. The air column 30 is formed from the airflow 26 as well as air from an area 31 that is generally radially exterior to air column 30. The air within the air column 30 flows upwards at an increased velocity relative to air from the area 31 that is generally radially exterior to air column 30, thereby causing a differential pressure zone 32 where the pressure is lowest at the point of the air column and increases with the radial distance from the air column until it reaches general atmospheric pressure.

The upper housing 40 contains an air intake opening 41 and encloses a frusto-conical insect trap 44 positioned with its wide end at the intake opening 41 of a mesh bag and its narrow end within the bag to encourage insects to enter but not leave the trap 44. The narrow end of the frusto-conical insect trap 44 is sized to channel the airflow from the intake opening 41 into the trap 44 and eliminate the escape capability of flying insects. The frusto-conical insect trap 44 comprises holes 45 within the sidewall and at the narrow end which are covered with a flexible flap 42A such that flap 42A is caused to open as shown in 42B by the airflow through the intake 41, and thus allow flying insects to enter the trap. Flap 42A will close when the insect capture device is not operating thereby preventing escape of insects from the trap 44. The trap 44 may be removed for emptying through a receptacle 47 or disposed of entirely. The insect trap 44 is a structure for inhibiting passage of insects but allowing air to pass substantially freely through it. The insect trap 44 may contain a screen material or the like or an adhesive covered surface for entrapping entrained insects.

The exhaust airflow 46 is directed upwards and deflected using a cover 48 such that it is exhausted away from the above the device 10 such that it creates a re-circulating air current 47 where flying insects are unable to escape the air current 47 and instead are directed to enter the differential pressure zone 32 or otherwise become entrained in the airflow 31 or airflow 23 entering the insect capture device.

The upper housing 40 further contains means for attaching or containing an odorant or other chemical attractant 50 such that the exhaust airflow 46 is utilized to expel chemical attractant from the unit. The insect chemical attractant 50 may be a liquid, solid, or gas-emitter selected from those well known in the art, including an appropriate insect pheromone, carbon dioxide, a kairomone, octenol, or such as may yet be discovered. The insect chemical attractant 50 is mixed with the exhaust flow 46 and discharged though openings 54 of a decorative housing 60 enclosing the upper housing 40.

The upper housing 40 further contains a light source attractant 52, wherein said light source is capable of emitting light of ultraviolet wavelengths as an additional attractant means. In the described embodiment, fan 22 has a nominal 100 mm opening and produces from at least 60 cubic feet per minute of airflow. Power 90 can be provided to the device 10 to operate the each fan and lights by any suitable and convenient means, such as, for example, batteries, solar panels or line power. The device 10 may attached to a standing fixture or suspended from a hook using attachment means 64.

Flying insects are drawn toward to the device 10 in reaction to the combination of visual, chemical, and thermal attractants. As the insects follow their target-seeking instincts, they are led naturally to the differential pressure zone 32 or lower area 23 and are drawn into the device 10 via the air column 30 or suction from the lower fan assembly 22, and are thereby urged by suction flow 31 to enter the insect trap 44 or urged by suction flow 23 to enter the insect trap 24.

While the foregoing descriptions include many details and specificities, it is to be understood that these have been included for purposes of explanation only, and are not to be interpreted as limitations of the present invention. Many modifications to the embodiments described above, such as providing additional fans, fan assemblies, fan housings, fan capacities, balancing plenums, and the selection of materials can be made without departing from the spirit and scope of the invention, as is intended to be encompassed by the following claims and their legal equivalents.

What is claimed is:

1. An apparatus for killing insects comprising:
one or more host targets for attracting flying insects using one or a combination of ultraviolet light, halogen light, heat, and chemical sensory emissions attractive to flying insects; an upper assembly for housing a host target, air current generator, an insect capture assembly, airflow emitting means, and mounting device; a lower assembly for housing a host target, air current generator, and an insect capture assembly, and mounting device; wherein the upper and lower housings are connected by a rod or other means in a manner to establish a vertical separation to accommodate an air column open to the atmosphere; said air column generated by one or more air current generators in the upper and/or lower assemblies to produce a uniform air current open to the atmosphere and flowing vertically at an increased relative speed to the atmosphere thereby creating a zone of differential pressure where the pressure is lowest at the interface between the air column and the atmosphere and increases to atmospheric pressure radially at a distance away from the air column; one or more insect capture assemblies located to receive the air current having a mesh or other means dimensioned to separate insects from the air current of the air column; and insect disabling means being arranged with the airflow mechanism to capture or otherwise disable and kill insects arriving into the device.

2. The device of claim 1, wherein the air current generator comprises a single fan assembly or multiple fan assemblies operating in series.

3. The device of claim 1, wherein the differential pressure urges insects into the air column for entrapment into the capture assembly.

4. The device of claim 1, further comprising mounting structure being adapted to position the device vertically within a decorative light housing for mounting on a wall or post or column.

5. An apparatus according to claim 1 wherein the apparatus further includes: a roof, means for hanging the apparatus, an outer protective shell, means adapted to connect the attracting device to a power supply, and means for catching dead insects.
